(19) United States
(12) Patent Application Publication
(10) Pub. No.: US 2025/0211854 A1
(43) Pub. Date: Jun. 26, 2025

(54) ELECTRONIC DEVICE, CONTROL METHOD OF ELECTRONIC DEVICE, AND NON-TRANSITORY COMPUTER READABLE MEDIUM

(71) Applicant: CANON KABUSHIKI KAISHA, Tokyo (JP)

(72) Inventor: TAKAHIRO KITSUNAI, Tokyo (JP)

(21) Appl. No.: 18/969,636

(22) Filed: Dec. 5, 2024

(30) Foreign Application Priority Data
Dec. 21, 2023 (JP) 2023-215488

(51) Int. Cl. H04N 23/67; H04N 23/55; H04N 23/63

(52) U.S. Cl. CPC H04N 23/67; H04N 23/55; H04N 23/631

(57) ABSTRACT

An electronic device according to the present disclosure includes a processor, and a memory storing a program which, when executed by the processor, causes the electronic device to execute acquisition processing of acquiring a captured image having a plurality of image areas captured through a plurality of optical systems, respectively, and execute display control processing of performing control to display the captured image, wherein, in a case where focus adjustment is performed in autofocus (AF), control is performed in the display control processing such that an image to be displayed is switched from the captured image to an enlarged image obtained by enlarging an area in which the AF is performable in any one of the plurality of image areas.

### BACKGROUND OF THE DISCLOSURE

### Field of the Disclosure

The present disclosure relates to an electronic device, a control method of the electronic device, and a non-transitory computer readable medium.

### Description of the Related Art

There is known a technique for acquiring an image having two image areas with a parallax using two optical systems facing the same direction and displaying the two image areas so as to allow stereoscopic vision thereof. There is also a camera to which a lens unit having two optical systems facing the same direction can be mounted and which can capture one image having two image areas with a parallax. When a circular fish-eye lens is used as each optical system, an image area vertically and horizontally indicating a wide range of 180 degrees (hemispherical, 90 degrees in all directions from image center) or more can be obtained as each image area.

### SUMMARY

In the case of using a plurality of optical systems, an object is captured to be smaller than in the case of using one optical system, and thus, it is difficult for a user to check a focus adjustment result. It is also conceivable to enlarge a partial area of a captured image in order to make it easier to check the focus adjustment result. However, the area to be enlarged differs depending on types of focus adjustment, and thus it is not sufficient to simply enlarge the area.

The present disclosure provides a technique capable of easily checking a focus adjustment result in specific focus adjustment (at least one of autofocus and manual focus).

The present disclosure in its first aspect provides an electronic device including a processor, and a memory storing a program which, when executed by the processor, causes the electronic device to execute acquisition processing of acquiring a captured image having a plurality of image areas captured through a plurality of optical systems, respectively, and execute display control processing of performing control to display the captured image, wherein, in a case where focus adjustment is performed in autofocus (AF), control is performed in the display control processing such that an image to be displayed is switched from the captured image to an enlarged image obtained by enlarging an area in which the AF is performable in any one of the plurality of image areas.

The present disclosure in its second aspect provides an electronic device including a processor, and a memory storing a program which, when executed by the processor, causes the electronic device to execute acquisition processing of acquiring a captured image having a plurality of image areas captured through a plurality of optical systems, respectively, and execute display control processing of performing control to display the captured image, wherein, in a case where focus adjustment is performed in manual focus (MF), control is performed in the display control processing such that an image to be displayed is switched from the captured image to an enlarged image obtained by enlarging any one of the plurality of image areas.

Further features of the present disclosure will become apparent from the following description of exemplary embodiments with reference to the attached drawings.

### BRIEF DESCRIPTION OF THE DRAWINGS

FIG. 1 is a schematic diagram illustrating an overall configuration of a system;

FIGS. 2A and 2B are external views of a camera;

FIG. 3 is a block diagram illustrating a configuration of the camera;

FIG. 4 is a schematic diagram illustrating a configuration of a lens unit;

FIG. 5 is a schematic diagram of a captured image;

FIG. 6 is a block diagram illustrating a logical configuration of the camera;

FIGS. 7A to 7C are schematic diagrams of display areas;

FIGS. 8A and 8B are schematic diagrams of enlarged images; and

FIG. 9 is a flowchart illustrating an operation of the camera.

### DESCRIPTION OF THE EMBODIMENTS

An embodiment of the present disclosure is described in detail with reference to the accompanying drawings. In the embodiment, a digital camera (imaging apparatus) will be described as an electronic device by way of illustration.

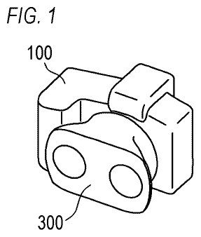

FIG. 1 is a schematic diagram illustrating an example of an entire configuration of a system according to the embodiment. The system according to the embodiment includes a digital camera (camera) 100 and a lens unit mounted on the camera 100. In FIG. 1, a lens unit 300 is mounted (connected) to the camera 100. Details of the lens unit 300 are described below, and by mounting the lens unit 300, the camera 100 can capture one image including two image areas (still image or moving image) with a predetermined parallax.

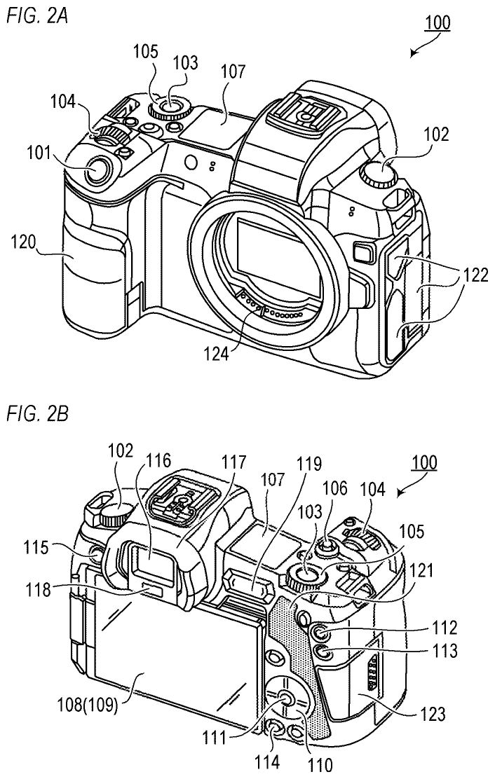

FIGS. 2A and 2B are external views illustrating an example of the appearance of the camera 100. FIG. 2A is a perspective view of the camera 100 viewed from the front side, and FIG. 2B is a perspective view of the camera 100 viewed from the back side.

The camera 100 includes, on its upper surface, a shutter button 101, a power switch 102, a mode selector switch 103, a main electronic dial 104, a sub-electronic dial 105, a movie button 106, and an outside viewfinder display unit 107. The shutter button 101 is an operation member for providing a shooting preparation instruction or a shooting instruction. The power switch 102 is an operation member for switching on or off of the power supply of the camera 100. The mode selector switch 103 is an operation member for switching among various modes. The main electronic dial 104 is a rotary operation member for changing setting values such as a shutter speed and an aperture value. The sub-electronic dial 105 is a rotary operation member for moving a selection frame (cursor) and feeding images. The movie button 106 is an operation member for providing an instruction to start or stop movie shooting (recording). The outside viewfinder display unit 107 displays various setting values such as a shutter speed and an aperture value.

The camera 100 includes, on the back surface, a display unit 108, a touch panel 109, a direction key 110, a SET button 111, an AE lock button 112, an enlargement button 113, a playback button 114, a menu button 115, an eyepiece portion 116, an eyepiece detection unit 118, and a touch bar 119. The display unit 108 displays images and various types of information. The touch panel 109 is an operation member for detecting a touch operation on the display surface (touch operation surface) of the display unit 108. The direction key 110 is an operation unit configured with keys that can be pressed up, down, left and right (four direction keys). Processing corresponding to the position where the direction key 110 is pressed can be performed. The SET button 111 is an operation member to be pressed mainly when a selected item is determined. The AE lock button 112 is an operation member to be pressed when an exposure state is fixed in a shooting standby state. The enlargement button 113 is an operation member for switching on or off an enlargement mode in live view display (LV display) of a shooting mode. In the case where the enlargement mode is switched on, a live view image (LV image) is enlarged or reduced by operating the main electronic dial 104. In addition, the enlargement button 113 is used for enlarging a playback image or increasing an enlargement ratio in a playback mode. The playback button 114 is an operation member for switching between the shooting mode and the playback mode. By pressing the playback button 114 in the shooting mode, the mode shifts to the playback mode, so that the latest one of images recorded in a recording medium 227, which will be described later, can be displayed on the display unit 108.

The menu button 115 is an operation member to be pressed for displaying a menu screen, which enables various settings, on the display unit 108. A user can intuitively perform the various settings by using the menu screen displayed on the display unit 108, the direction key 110, and the SET button 111. The eyepiece portion 116 is a portion in which the user approaches and looks through an eyepiece viewfinder (looking-through type viewfinder) 117 with the eyes. The user can visually confirm video displayed on an electronic view finder (EVF) 217 described below in the camera 100 through the eyepiece portion 116. The eyepiece detection unit 118 is a sensor for detecting whether an eye of the user is placed near the eyepiece portion 116 (eyepiece viewfinder 117).

The touch bar 119 is a linear touch operation member (line touch sensor) capable of receiving a touch operation. The touch bar 119 is disposed at a position that enables a touch operation (touchable) with the thumb finger of the right hand in a state in which a grip portion 120 is gripped with the right hand (a state in which the grip portion 120 is gripped with the little finger, the ring finger, and the middle finger of the right hand) such that the shutter button 101 can be pressed by the index finger of the right hand. That is, the touch bar 119 can be operated in a state in which the user approaches to the eyepiece viewfinder 117 with the eyes, looks through the eyepiece portion 116, and holds up the camera 100 so as to be able to press the shutter button 101 at any time (shooting orientation). The touch bar 119 can receive a tapping operation on the touch bar 119 (an operation of touching the touch bar and releasing the touch bar without moving the touch position within a predetermined period of time), a sliding operation to the left or right (an operation of touching the touch bar and then moving the touch position while keeping the touch), and the like. The touch bar 119 is an operation member that is different from the touch panel 109 and does not have a display function. The touch bar 119 acts as, for example, a multi-function bar (M-Fn bar) where various functions can be allocated.

In addition, the camera 100 also has a grip portion 120, a thumb rest portion 121, a terminal cover 122, a lid 123, and a communication terminal 124. The grip portion 120 is a holding portion formed in a shape easy for the user to grip with the right hand when the user holds the camera 100. The shutter button 101 and the main electronic dial 104 are arranged at positions that allow the user to operate the shutter button 101 and the main electronic dial 104 with the index finger of the right hand in a state in which the user holds the camera 100 while gripping the grip portion 120 with the little finger, the ring finger, and the middle finger of the right hand. Also, in the same state, the sub-electronic dial 105 and the touch bar 119 are arranged at positions where the user can operate the sub-electronic dial 105 and the touch bar 119 with the thumb finger of the right hand. The thumb rest portion 121 (thumb standby position) is a grip portion provided at a place where it is easy for the user to place the thumb finger of the right hand that grips the grip portion 120 on the back side of the camera 100 in a state in which any of the operation members is not operated. The thumb rest portion 121 is configured with a rubber member for enhancing the holding power (gripping feeling). The terminal cover 122 protects connectors such as connection cables for connecting the camera 100 to external devices (external equipment). The lid 123 closes a slot for storing the recording medium 227 described below, to protect the recording medium 227 and the slot. The communication terminal 124 is a terminal for communication with a lens unit (a lens unit 200, a lens unit 300, or the like described below) attachable to and detachable from the camera 100.

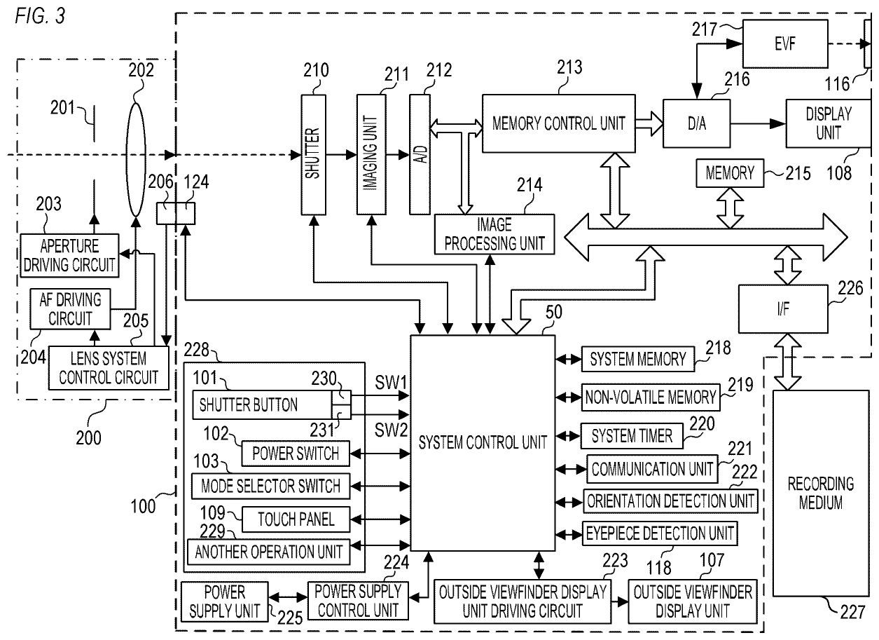

FIG. 3 is a block diagram illustrating an example of the configuration of the camera 100. In FIG. 3, the same components as those in FIGS. 2A and 2B are denoted by the same reference numerals as in FIGS. 2A and 2B, and description thereof is appropriately omitted. In FIG. 3, the lens unit 200 is mounted to the camera 100.

First, the lens unit 200 will be described. The lens unit 200 is a type of an interchangeable-lens unit that is attachable to and detachable from the camera 100. The lens unit 200 is a single-lens unit and is an example of a typical lens unit. The lens unit 200 includes an aperture 201, a lens 202, an aperture driving circuit 203, an autofocus (AF) driving circuit 204, a lens system control circuit 205, and a communication terminal 206, and the like.

The aperture 201 is configured with an adjustable aperture diameter. The lens 202 is configured with a plurality of lenses. The aperture driving circuit 203 adjusts a quantity of light by controlling the aperture diameter of the aperture 201. The AF driving circuit 204 adjusts focus by driving the lens 202. The lens system control circuit 205 controls the aperture driving circuit 203, the AF driving circuit 204, and the like based on instructions from a system control unit 50 described below. The lens system control circuit 205 controls the aperture 201 via the aperture driving circuit 203 and adjusts the focus by changing the position of the lens 202 via the AF driving circuit 204. The lens system control circuit 205 can communicate with the camera 100. Specifically, the communication is performed via the communication terminal 206 of the lens unit 200 and the communication terminal 124 of the camera 100. The communication terminal 206 is a terminal that allows the lens unit 200 to communicate with the camera 100 side.

The camera 100 will be described below. The camera 100 includes a shutter 210, an imaging unit 211, an A/D converter 212, a memory control unit 213, an image processing unit 214, a memory 215, a D/A converter 216, the EVF 217, the display unit 108, and the system control unit 50.

The shutter 210 is a focal-plane shutter capable of freely controlling the exposure time of the imaging unit 211 based on an instruction of the system control unit 50. The imaging unit 211 is an imaging element (image sensor) configured with a CCD, a CMOS element, or the like that convert an optical image into an electrical signal. The imaging unit 211 may include an imaging-surface phase-difference sensor for outputting defocus-amount information to the system control unit 50. The A/D converter 212 converts an analog signal output from the imaging unit 211 into a digital signal. The image processing unit 214 performs predetermined processing (pixel interpolation, resizing processing such as reduction, color conversion processing, and the like) on data from the A/D converter 212 or data from the memory control unit 213. Moreover, the image processing unit 214 performs predetermined arithmetic processing by using captured image data, and the system control unit 50 performs exposure control and distance measurement control based on the obtained result of arithmetic processing. By this processing, through-the-lens (TTL)-type AF processing, auto exposure (AE) processing, EF (flash pre-flash) processing, and the like are performed. Furthermore, the image processing unit 214 performs predetermined arithmetic processing by using the captured image data, and the system control unit 50 performs TTL auto white balance (AWB) processing based on the obtained result of arithmetic processing.

Image data from the A/D converter 212 is written into the memory 215 via the image processing unit 214 and the memory control unit 213. Alternatively, the image data from the A/D converter 212 is written into the memory 215 via the memory control unit 213 without the intervention of the image processing unit 214. The memory 215 stores the image data that is obtained by the imaging unit 211 and is converted into digital data by the A/D converter 212 and image data to be displayed on the display unit 108 or the EVF 217. The memory 215 includes a storage capacity sufficient to store a predetermined number of still images and a predetermined length of moving images and voice. The memory 215 also serves as a memory for image display (video memory).

The D/A converter 216 converts image data for display stored in the memory 215 into an analog signal, and supplies the analog signal to the display unit 108 or the EVF 217. Accordingly, the image data for display written into the memory 215 is displayed on the display unit 108 or the EVF 217 via the D/A converter 216. The display unit 108 and the EVF 217 provide display in response to the analog signal from the D/A converter 216. The display unit 108 and the EVF 217 are, for example, LCD or organic EL displays. The digital signal that is A/D converted by the A/D converter 212 and is accumulated in the memory 215 is converted into the analog signal in the D/A converter 216, and the analog signal is sequentially transferred to and displayed on the display unit 108 or the EVF 217, so that live view display is performed.

The system control unit 50 is a control unit including at least one processor and/or at least one circuit. That is, the system control unit 50 may be a processor, may be a circuit, or may be a combination of a processor and a circuit. The system control unit 50 controls the entire camera 100. The system control unit 50 implements the processing of flowcharts described below, by executing programs recorded in a nonvolatile memory 219. In addition, the system control unit 50 also performs display control by controlling the memory 215, the D/A converter 216, the display unit 108, the EVF 217, and the like.

The camera 100 also includes a system memory 218, the nonvolatile memory 219, a system timer 220, a communication unit 221, an orientation detection unit 222, and the eyepiece detection unit 118.

For example, a RAM is used as the system memory 218. In the system memory 218, constants, variables, and programs read from the nonvolatile memory 219 for the operation of the system control unit 50 are loaded. The nonvolatile memory 219 is an electrically erasable and recordable memory. For example, an EEPROM is used as the nonvolatile memory 219. In the nonvolatile memory 219, constants, programs, and the like for the operation of the system control unit 50 are recorded. The program as used herein includes programs for performing the flowcharts described below. The system timer 220 is a timer unit that counts time used for various types of control and time of a built-in clock. The communication unit 221 transmits and receives a video signal and a voice signal to and from external device connected wirelessly or via a wired cable. The communication unit 221 is also connectable to a wireless local area network (LAN) and the Internet. Moreover, the communication unit 221 can communicate with external device also via Bluetooth (registered trademark) and Bluetooth Low Energy. The communication unit 221 can transmit an image captured by the imaging unit 211 (including a live image) and an image recorded in the recording medium 227 and can receive an image and other various types of information from external equipment. The orientation detection unit 222 detects the orientation of the camera 100 with respect to the direction of gravity. Based on the orientation detected by the orientation detection unit 222, whether an image shot by the imaging unit 211 is an image shot with the camera 100 held in a horizontal position or held in a vertical position can be determined. The system control unit 50 can add orientation information in accordance with the orientation detected by the orientation detection unit 222 to an image file of the image shot by the imaging unit 211 and can rotate the image according to the detected orientation. For example, an acceleration sensor or a gyro sensor can be used for the orientation detection unit 222. It is possible to also detect the movement of the camera 100 (whether it is panning, tilting, lifting, stationary, or the like) by using the orientation detection unit 222.

The eyepiece detection unit 118 can detect an object approaching the eyepiece portion 116 (eyepiece viewfinder 117). For example, an infrared proximity sensor can be used as the eyepiece detection unit 118. When an object approaches, infrared light emitted from a light-emitting portion of the eyepiece detection unit 118 is reflected on the object and is received by a light-receiving portion of the infrared proximity sensor. A distance from the eyepiece portion 116 to the object can be determined according to the amount of received infrared light. In this way, the eyepiece detection unit 118 performs eye approach detection for detecting a distance between the eyepiece portion 116 and the object approaching the eyepiece portion 116. The eyepiece detection unit 118 is an eyepiece detection sensor that detects approach (eye approach) and separation (eye separation) of an eye (object) to and from the eyepiece portion 116. In a case where an object approaching the eyepiece portion 116 within a predetermined distance is detected in a non-eye approach state (non-approach state), the eyepiece detection unit 118 detects that an eye approaches. Meanwhile, in a case where the object of which the approach is detected is separated by a predetermined distance or longer in an eye approach state (approach state), the eyepiece detection unit 118 detects that an eye is separated. A threshold value for detecting the eye approach and a threshold value for detecting the eye separation may be different for providing, for example, a hysteresis. In addition, after the eye approach is detected, the eye approach state is assumed until the eye separation is detected. After the eye separation is detected, the non-eye approach state is assumed until the eye approach is detected. The system control unit 50 switches between display (display state) and non-display (non-display state) of each of the display unit 108 and the EVF 217 according to the state detected by the eyepiece detection unit 118. Specifically, in a case where at least the shooting standby state is established, and a switching setting for a display destination is set to automatic switching, the display destination is set as the display unit 108, and the display is turned on, while the EVF 217 is set to non-display during the non-eye approach state. Also, during the eye approach state, the EVF 217 is set as the display destination, and the display is turned on, while the display unit 108 is set to non-display. Note that the eyepiece detection unit 118 is not limited to the infrared proximity sensor, and other sensors may be used as the eyepiece detection unit 118 as long as the sensors can detect the state which can be regarded as the eye approach.

The camera 100 also has the outside viewfinder display unit 107, an outside viewfinder display unit driving circuit 223, a power supply control unit 224, a power supply unit 225, a recording medium I/F 226, and an operation unit 228.

The outside viewfinder display unit 107 is driven by the outside viewfinder display unit driving circuit 223 and displays various setting values for the camera 100 such as a shutter speed and an aperture value. The power supply control unit 224 is configured with a battery detection circuit, a DC-DC converter, a switch circuit that switches the block to be energized, and the like and detects whether a battery is mounted, the type of battery, the remaining battery level, and the like. Moreover, the power supply control unit 224 controls the DC-DC converter based on the detection result and an instruction from the system control unit 50 and supplies a required voltage to portions including the recording medium 227 for a necessary period of time. The power supply unit 225 is a primary battery such as alkaline and lithium batteries, a secondary battery such as NiCd, NiMH, and Li batteries, an AC adapter, or the like. The recording medium I/F 226 is an interface to the recording medium 227 such as a memory card and a hard disk. The recording medium 227 is a memory card for recording shot images, and the like and is configured with a semiconductor memory, a magnetic disk, and the like. The recording medium 227 may be attachable to and detachable from the camera 100 or may also be embedded in the camera 100.

The operation unit 228 is an input unit that receives an operation from the user (user operation) and is used for inputting various instructions to the system control unit 50. The operation unit 228 includes the shutter button 101, the power switch 102, the mode selector switch 103, the touch panel 109, another operation unit 229, and the like. The other operation units 229 include, for example, the main electronic dial 104, the sub-electronic dial 105, the movie button 106, the direction key 110, the SET button 111, the AE lock button 112, the enlargement button 113, the playback button 114, the menu button 115, and the touch bar 119.

The shutter button 101 includes a first shutter switch 230 and a second shutter switch 231. The first shutter switch 230 is turned on in the middle of the operation of the shutter button 101 in response to so-called half-press (shooting preparation instruction) and outputs a first shutter switch signal SW1. The system control unit 50 starts shooting preparation processing such as AF processing, AE processing, AWB processing, and EF processing in response to the first shutter switch signal SW1. The second shutter switch 231 is turned on at the completion of the operation of the shutter button 101 in response to so-called full-press (shooting instruction) and outputs a second shutter switch signal SW2. In response to the second shutter switch signal SW2, the system control unit 50 starts a sequence of shooting processing involving reading of a signal from the imaging unit 211, generating an image file including the shot image, and writing of the generated image file into the recording medium 227.

The mode selector switch 103 switches the operation mode of the system control unit 50 to any one of a still image shooting mode, a movie shooting mode, and a playback mode. Examples of the modes of the still image shooting mode include an auto shooting mode, an auto scene-determination mode, a manual mode, an aperture-priority mode (Av mode), a shutter-speed priority mode (Tv mode), and a program AE mode (P mode). The mode also includes various scene modes which have shooting settings for different shooting scenes, a custom mode, and the like. The user can directly switch the mode to any of the above-described shooting modes with the mode selector switch 103. Alternatively, the user can temporarily switch a screen to a list screen of the shooting modes with the mode selector switch 103 and then selectively switch the mode to any of the plurality of displayed modes with the operation unit 228. Likewise, the movie shooting mode may include a plurality of modes.

The touch panel 109 is a touch sensor for detecting various touch operations on the display surface of the display unit 108 (the operation surface of the touch panel 109). The touch panel 109 and the display unit 108 can be integrally configured. For example, the touch panel 109 is attached to an upper layer of the display surface of the display unit 108 such that the transmittance of light does not hinder the display on the display unit 108. Furthermore, input coordinates on the touch panel 109 and display coordinates on the display surface of the display unit 108 are associated with each other, thereby configuring a graphical user interface (GUI) such that the user can directly operate a screen displayed on the display unit 108. The touch panel 109 can use any of various methods including resistive film, capacitive, surface acoustic wave, infrared, electromagnetic induction, image recognition, optical sensor methods, and the like. Depending on the methods, there are a method of detecting a touch based on contact with the touch panel 109, and a method of detecting a touch based on approach of a finger or a pen to the touch panel 109, but any method may be adopted.

For the touch panel 109, the system control unit 50 can detect the following operations or states:
An operation in which a finger or a pen that is not in contact with the touch panel 109 newly touches the touch panel 109, that is, a start of a touch (hereinafter referred to as touch-down).
A state in which the finger or the pen is in contact with the touch panel 109 (hereinafter referred to as touch-on).
An operation in which the finger or the pen is moving while being in contact with the touch panel 109 (hereinafter referred to as touch-move).
An operation in which the finger or the pen that is in contact with the touch panel 109 is separated from (released from) the touch panel 109, that is, an end of the touch (hereinafter referred to as touch-up).
A state in which nothing is in contact with the touch panel 109 (hereinafter referred to as touch-off).

When the touch-down is detected, the touch-on is detected at the same time. After the touch-down, the touch-on is continuously detected normally unless the touch-up is detected. Also, when the touch-move is detected, the touch-on is continuously detected. Even if the touch-on is detected, the touch-move is not detected as long as the touch position is not moved. After the touch-up of all the fingers and the pen having been in contact with the touch panel 109 is detected, the touch-off is established.

These operations and states and the position coordinates of the finger or the pen that is in contact with the touch panel 109 are notified to the system control unit 50 through an internal bus. The system control unit 50 determines what kind of operation (touch operation) is performed on the touch panel 109, based on the notified information. With regard to the touch-move, a movement direction of the finger or the pen moving on the touch panel 109 can be determined for each vertical component and for each horizontal component on the touch panel 109, based on change of the position coordinates. When the touch-move for a predetermined distance or longer is detected, it is determined that a sliding operation is performed. An operation in which a finger is swiftly moved by a certain distance while being in contact with the touch panel 109 and is separated is referred to as a flick. In other words, the flick is an operation in which the finger is swiftly slid on the touch panel 109 so as to flick the touch panel 109. When the touch-move for a predetermined distance or longer at a predetermined speed or higher is detected, and then the touch-up is detected without change, it is determined that the flick is performed (it can be determined that the flick is performed subsequently to the sliding operation). Furthermore, a touch operation in which a plurality of places (for example, two points) are both touched (multi-touched) and the touch positions are brought close to each other is referred to as pinch-in, and a touch operation in which the touch positions are moved away from each other is referred to as pinch-out. The pinch-out and the pinch-in are collectively referred to as a pinching operation (or simply referred to as a pinch).

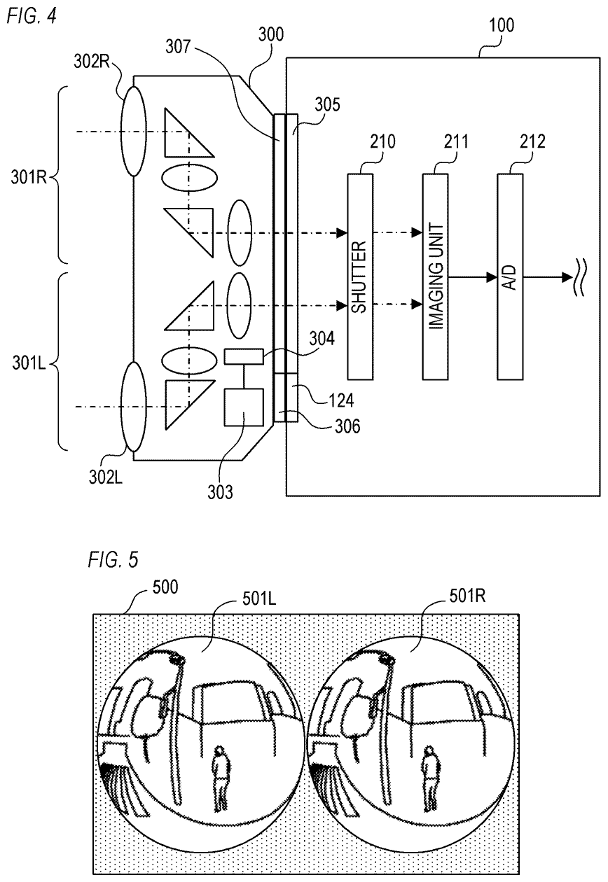

FIG. 4 is a schematic diagram illustrating an example of the configuration of the lens unit 300. FIG. 4 illustrates a state in which the lens unit 300 is mounted to the camera 100. In the camera 100 illustrated in FIG. 4, the same constituent elements as those of FIG. 3 are indicated by the same reference numerals as in FIG. 3, and an explanation thereof is optionally omitted.

The lens unit 300 is a type of an interchangeable lens unit attachable to and detachable from the camera 100. The lens unit 300 is a dual-lens unit capable of capturing a right image and a left image having a parallax. The lens unit 300 includes two optical systems, and each of the two optical systems can capture an image in a range at a wide viewing angle of about 180 degrees. Specifically, each of the two optical systems of the lens unit 300 can capture an image of an object corresponding to a field of view (angle of view) of 180 degrees in the left-to-right direction (horizontal angle, azimuth angle, yaw angle) and 180 degrees in the up-and-down direction (vertical angle, elevation angle, pitch angle). That is, each of the two optical systems can capture an image in a front hemispherical range.

The lens unit 300 includes a right-eye optical system 301R including a plurality of lenses, reflecting mirrors, and the like, a left-eye optical system 301L including a plurality of lenses, reflecting mirrors, and the like, a lens system control circuit 303, and a focus driving circuit 304. The right-eye optical system 301R includes a lens 302R disposed near the object, and the left-eye optical system 301L includes a lens 302L disposed near the object. The lens 302R and the lens 302L are oriented in the same direction and the optical axes thereof are substantially parallel to each other.

The lens system control circuit 303 controls the focus driving circuit 304. The lens system control circuit 303 changes positions of the lens 302R and the lens 302L via the focus driving circuit 304 and adjusts the focus. The focus driving circuit 304 drives the lens 302L in conjunction with the lens 302R. That is, adjustment of focus is performed in the entire lens unit 300. The adjustment of focus prevents defocus from occurring between a right image formed through the right-eye optical system 301R and a left image formed through the left-eye optical system 301L. Note that, in a case where defocus occurs between the right image and the left image, the user can cause an adjustment unit (not illustrated in FIG. 4) to perform fine adjustment.

The lens unit 300 is a dual-lens unit (VR180 lens unit) for obtaining a VR180 image which is one of virtual reality (VR) image formats capable of binocular stereoscopic vision. In the lens unit 300, each of the right-eye optical system 301R and the left-eye optical system 301L includes a fish-eye lens capable of capturing a range of about 180 degrees. Note that the range that can be captured by the lens of each of the right-eye optical system 301R and the left-eye optical system 301L may be a range of about 160 degrees narrower than the range of 180 degrees. The lens unit 300 can form the right image formed through the right-eye optical system 301R and the left image formed through the left-eye optical system 301L on one or two imaging elements of the camera to which the lens unit 300 is mounted. In the camera 100, the right image and the left image are formed on one imaging element (imaging sensor), and one image (binocular image) in which a right image area (area of right image) and a left image area (area of left image) are arranged side by side is generated.

The lens unit 300 is mounted to the camera 100 via a lens mount portion 307 and a camera mount portion 305 of the camera 100. In this manner, the system control unit 50 of the camera 100 and the lens system control circuit 303 of the lens unit 300 are thus electrically connected to each other via the communication terminal 124 of the camera 100 and a communication terminal 306 of the lens unit 300.

FIG. 5 is a schematic diagram illustrating an example of a captured image 500 of the camera 100. In FIG. 5, a right image area 501R formed through the right-eye optical system 301R and a left image area 501L formed through the left-eye optical system 301L are arranged side by side (as a set) by the imaging unit 211 of the camera 100. In other words, the right-eye optical system 301R and the left-eye optical system 301L form two optical images (object images) in the two areas of one imaging element (image sensor). The imaging unit 211 converts the formed optical image (optical signal) into an analog electrical signal. By using the lens unit 300 in this manner, one image including two image areas having a parallax can be acquired from two places (optical systems), that is, the right-eye optical system 301R and the left-eye optical system 301L. By dividing the acquired image into an image for the left eye and an image for the right eye and providing the images in VR display, the user can view a stereoscopic VR image about in a 180-degree range. In other words, the user can view a VR180 image stereoscopically. Note that, in the example of FIG. 5, each of the left image area 501L and the right image area 501R is an area of a circular fish-eye image.

In this case, the VR image is an image that can be viewed in VR display described below. Examples of VR images include an omnidirectional image (whole spherical image) captured by an omnidirectional camera (whole spherical camera) and a panoramic image having a wider video range (effective video range) than a display range that can be displayed at once on a display unit. Examples of VR images also include a moving image and a live image (an image acquired substantially in real time from a camera), as well as a still image. The VR image has a maximum video range (effective video range) corresponding to a field of view of 360 degrees in a left-to-right direction and 360 degrees in an up-and-down direction. Examples of the VR image also include images having an angle of view wider than an angle of view that can be captured by a normal camera or a video range wider than a display range that can be displayed at a time in the display unit, even when the angle of view or video range is smaller than 360 degrees in the left-to-right direction and smaller than 360 degrees in the up-and-down direction. An image captured by the camera 100 with the lens unit 300 described above is a type of the VR image. The VR image can be viewed in VR display by setting, for example, the display mode of a display device (a display device capable of displaying a VR image) at “VR view”. A certain range of a VR image with a 360-degree angle of view may be displayed, and the user can move the displayed range by changing the orientation of the display device in the left-to-right direction (horizontal rotation direction), so that a seamless omnidirectional video in the left-to-right direction can be viewed.

The VR display (VR view) is a display method (display mode) for displaying, from among VR images, video in a field-of-view range in accordance with the orientation of the display device, the display method being capable of changing a display range. Examples of the VR display include “single-lens VR display (single-lens VR view)” in which one image is displayed after deformation (distortion correction) for mapping a VR image on a virtual sphere. Examples of the VR display include “dual-lens VR display (dual-lens VR view)” in which a left-eye VR image and a right-eye VR image are displayed in left and right areas side by side after deformation for mapping the VR images on a virtual sphere. The “dual-lens VR display” is performed by using the left-eye VR image and the right-eye VR image having a parallax, thereby achieving a stereoscopic vision of the VR images. In any type of VR display, for example, when the user wears a display device such as a head mounted display (HMD), video in the field-of-view range corresponding to the orientation of the user's face is displayed. For example, it is assumed that from among the VR images, video is displayed in a field-of-view range having the center thereof at 0 degrees in the left-to-right direction (a specific cardinal point, for example, the north) and 90 degrees in the up-and-down direction (90 degrees from the zenith, that is, the horizon) at a certain point in time. In this state, if the orientation of the display device is reversed (for example, the display surface is changed from a southern direction to a northern direction), from among the same VR images, the display range is changed to a video image in a field-of-view range having the center thereof at 180 degrees in the left-to-right direction (the opposite orientation, such as the south) and 90 degrees in the up-and-down direction. In other words, when the user wearing the HMD faces the south from the north (or looks back), the video image displayed on the HMD is changed from a video image of the north to a video image of the south. Note that the VR image captured with the lens unit 300 is an image (180-degree image) obtained by capturing the range of about 180 degrees in the front, and there are no video images in the range of about 180 degrees in the rear. In the VR display of such an image, when the orientation of the display device is changed to a side where video does not exist, a blank area is displayed.

Such VR display of a VR image makes the user feel like staying in the VR image (VR space) in a visual form (sense of immersion). Note that the VR image display method is not limited to the method for changing the orientation of the display device. For example, the display range may be moved (scrolled) in response to a user operation via a touch panel, directional buttons, or the like. In addition to the change of the display range by changing the orientation during the VR display (in the “VR View” display mode), the display range may be changed in response to the touch-move on the touch panel, a dragging operation with a mouse device or the like, or pressing the directional buttons. A smartphone mounted to VR goggles (head-mounted adapter) is a type of the HMD.

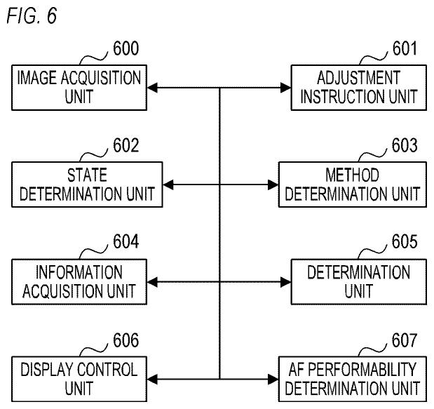

FIG. 6 is a block diagram illustrating an example of a logical configuration (software configuration) of the camera 100.

An image acquisition unit 600 acquires a captured image having a plurality of image areas captured through a plurality of optical systems, respectively. For example, as illustrated in FIG. 5, the image acquisition unit 600 acquires the captured image 500 in which a right image area 501R formed through the right-eye optical system 301R and a left image area 501L formed through the left-eye optical system 301L are arranged side by side.

An adjustment instruction unit 601 instructs the lens system control circuit 303 to adjust the focus in response to a focus adjustment operation (an operation of adjusting the focus) by the user. The focus adjustment operation may be an operation on the camera 100, an operation on the lens unit 300, or an operation on an external device connected via the communication unit 221. The focus adjustment operation on the camera 100 is, for example, a half-pressing operation of the shutter button 101 of the camera 100 or a touch operation on the touch panel 109. The focus adjustment operation on the lens unit 300 is, for example, an operation of turning a focus ring of the lens unit 300. The focus adjustment operation on the external device is, for example, an operation of issuing an instruction to adjust the focus with an app on the external device.

A state determination unit 602 determines whether or not the focus is being adjusted. There are two types of focus adjustment methods of autofocus (AF) in which the camera 100 and the lens unit 300 automatically adjust the focus, and manual focus (MF) in which the user adjusts the focus. If a focus position is being calculated or the lenses 302R and 302L are being driven, the state determination unit 602 determines that the focus is being adjusted in the AF, and otherwise, determines that the focus is not being adjusted. If the user turns the focus ring, the state determination unit 602 determines that the focus is being adjusted in the MF, and if not, the state determination unit determines that the focus is not being adjusted.

A method determination unit 603 determines whether the focus adjustment method is the AF or the MF. For example, an AF mode or an MF mode can be set in the camera 100 or the lens unit 300, and the method determination unit 603 determines the focus adjustment method depending on the set mode. Note that the determination method is not particularly limited as long as it can be determined whether the focus adjustment method is the AF or the MF.

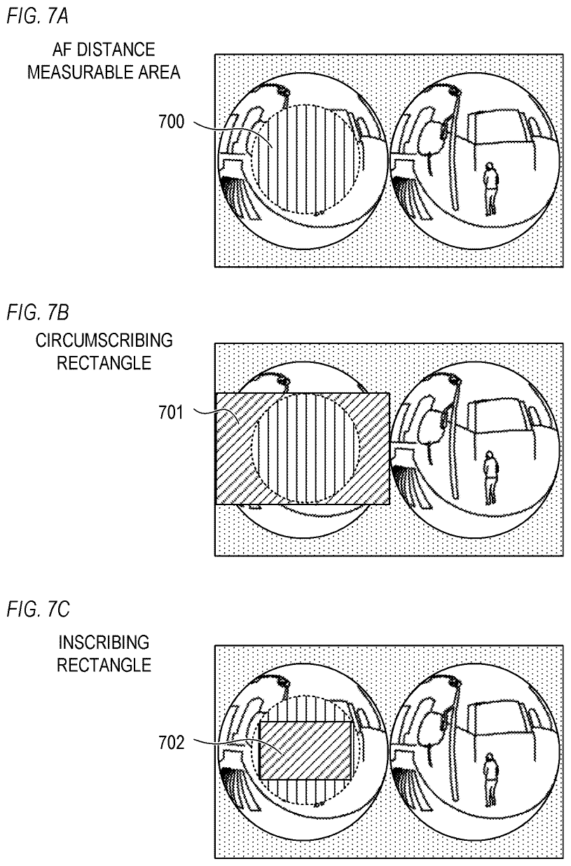

An information acquisition unit 604 acquires information about AF distance measurable area from the camera 100 and the lens unit 300. The AF distance measurable area is an area in which the AF can be performed. The AF distance measurable area may be construed as a distance measurable area. An area 700 in FIG. 7A is an AF distance measurable area. The information acquisition unit 604 acquires, for example, information about the AF distance measurable area at an image height from an optical center (a center of the right image area or the left image area). The information about the AF distance measurable area may be any information for enabling a corresponding area to be identified, and in a case where a shape of the AF distance measurable area is a rectangle, the information may be information of coordinates, a width, and a height of an upper left corner of the rectangle.

A determination unit 605 determines an area which is displayed (display area) during focus adjustment. Here, in a case where two optical systems such as the lens unit 300 are used, an object is captured to be smaller than in the case of using one optical system, and thus, it is difficult for a user to check a focus adjustment result. If an area which is checked at the time of focus adjustment is enlarged, the user can easily check the focus adjustment result. However, the AF and the MF differ from each other in how to adjust focus and how to check focus, and thus have different areas which need to be enlarged.

Hence, the determination unit 605 determines the display area such that the focus adjustment result can be easily checked in both the AF and the MF.

In a case where the focus adjustment is performed in the AF, the user checks whether focus is adjusted at an intended place by looking at the AF distance measurable area. Therefore, it is preferable to easily check the AF distance measurable area at the time of focus adjustment in the AF. Hence, in a case where the focus adjustment is performed in the AF, the determination unit 605 determines an AF distance measurable area in any one of the plurality of image areas (the right image area or the left image area) as a display area.

In FIG. 7A, the area 700 is the AF distance measurable area. The area 700 has a circular shape. As described above, the AF distance measurable area may have a shape other than a rectangle, but the EVF 217 and the display unit 108 that display the display area often have a rectangular shape. Hence, the determination unit 605 may determine only the area 700 as the display area, or may determine a rectangular area including the area 700 as the display area. For example, as illustrated in FIG. 7B, the determination unit 605 may determine a circumscribing rectangular area 701 of the area 700 as the display area. The area 701 is in contact with an upper side and a lower side of the area 700, and is not in contact with a right side and a left side thereof, but may be in contact with the right side and the left side thereof. As illustrated in FIG. 7C, the determination unit 605 may determine an inscribing rectangular area 702 of the area 700 as the display area. The present disclosure is not limited thereto, and the determination unit 605 may determine the display area to include the AF distance measurable area.

In a case where the focus adjustment is performed in the MF, the determination unit 605 determines any one of the plurality of image areas (the right image area or the left image area) as a display area. In the case of the MF, there is no area such as the AF distance measurable area, and it is not necessary to set a limitation on an area which is checked by the user. As described above, the focus driving circuit 304 drives the lens 302L in conjunction with the lens 302R and adjusts focus. Therefore, a difference between the right image area and the left image area is only a parallax, and in the MF in which focus is mainly adjusted visually, it is more important that any image is easily checked than that a parallax can be checked.

A display control unit 606 controls the EVF 217 or the display unit 108 to display the captured image acquired by the image acquisition unit 600. In a case where the focus adjustment is performed, the display control unit 606 performs control to switch the captured image to an enlarged image obtained by enlarging the display area determined by the determination unit 605. Note that, in a case where the camera 100 is connected to an external device, the display control unit 606 may perform control to display the captured image or the enlarged image on a display of the external device.

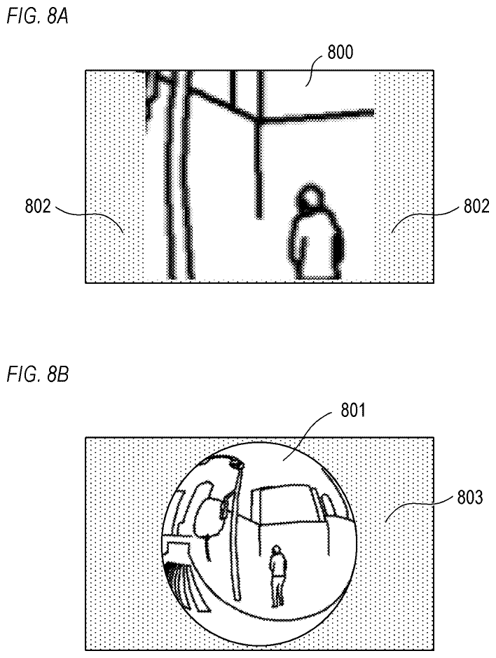

FIG. 8A is a schematic diagram of an enlarged image obtained in a case where the focus adjustment is performed in the AF. An image 800 is an image obtained by enlarging the area (the AF distance measurable area) 702 in FIG. 7C. In FIG. 8A, black image areas 802 are provided on the left and right of the image 800. A width of the area 802 may be larger (smaller) than an example in FIG. 8A. An aspect ratio of the AF distance measurable area may be the same as an aspect ratio of the EVF 217 or the display unit 108, and the area 802 may not be displayed.

FIG. 8B is a schematic diagram of an enlarged image obtained in a case where focus processing is performed in the MF. An image 801 is an image obtained by enlarging the left image area 501L in FIG. 5. In FIG. 8B, the entire left image area 501L is displayed. Note that the image 801 may be an image obtained by enlarging the right image area 501R.

The image 800 in FIG. 8A (the enlarged image obtained in the case where the focus adjustment is performed in the AF) is an equirectangular image, and the image 801 in FIG. 8B (the enlarged image obtained in the case where the focus adjustment is performed in the MF) is a circular fish-eye image. The enlarged image obtained in the case where the focus adjustment is performed in the AF may be the circular fish-eye image, and the enlarged image obtained in the case where the focus adjustment is performed in the MF may be the equirectangular image. Both the enlarged image obtained in the case where the focus adjustment is performed in the AF and the enlarged image obtained in the case where the focus adjustment is performed in the MF may be the equirectangular images or the circular fish-eye images. Both the enlarged images may be perspective projection images, instead of the circular fish-eye images or the equirectangular images.

The following description returns to FIG. 6. An AF performability determination unit 607 determines whether or not the camera 100 and the lens mounted on the camera 100 can perform the AF.

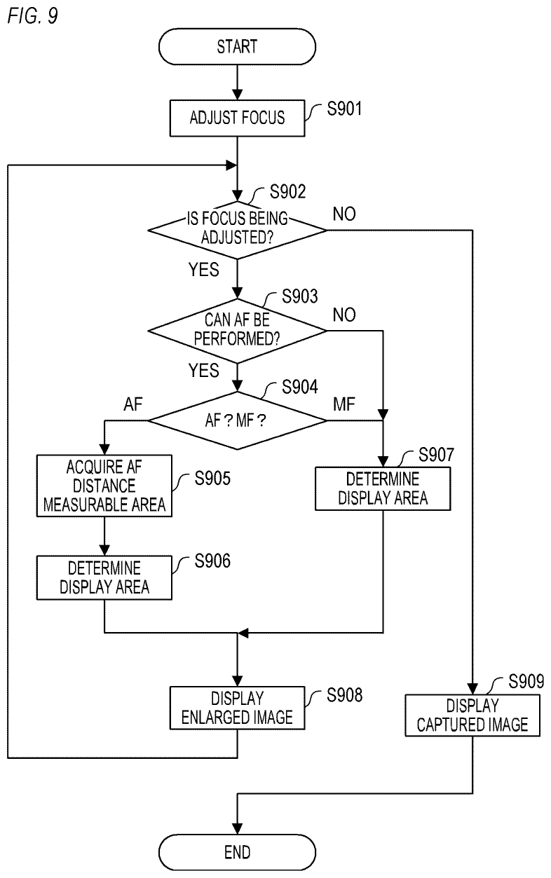

FIG. 9 is a flowchart illustrating an example of an operation of the camera 100. The operation is implemented by loading a program recorded in the nonvolatile memory 219 into the system memory 218 and executing the program by the system control unit 50. For example, when the user performs the focus adjustment operation, the operations of FIG. 9 start.

In step S901, the system control unit 50 (the adjustment instruction unit 601) instructs the lens system control circuit 303 to perform the adjustment of focus.

In step S902, the system control unit 50 (the state determination unit 602) determines whether or not focus is being adjusted. In the case where the focus is being adjusted, the processing proceeds to step S903, and in a case where the focus is not being adjusted, the process proceeds to step S909.

In step S903, the system control unit 50 (the AF performability determination unit 607) determines whether or not the AF can be performed. In the case where the AF can be performed, the processing proceeds to step S904, and in a case where the AF cannot be performed, the process proceeds to step S907. For example, if the lens capable of performing the AF is mounted, the processing proceeds to step S904, and if the lens capable of performing the AF is not mounted, the processing proceeds to step S907.

In step S904, the system control unit 50 (the method determination unit 603) determines whether the focus adjustment method is the AF or the MF. In the case of the AF, the processing proceeds to step S905, and in the case of the MF, the processing proceeds to step S907.

In step S905, the system control unit 50 (the information acquisition unit 604) acquires information about the AF distance measurable area in the left image area or the right image area.

In step S906, the system control unit 50 (the determination unit 605) determines the AF distance measurable area as the display area on the basis of the information of the AF distance measurable area acquired in step S905.

In step S907, the system control unit 50 (the determination unit 605) determines the left image area or the right image area as the display area.

In Step S908, the system control unit 50 (the display control unit 606) displays the enlarged image obtained by enlarging the display area determined in step S906 or step S907 on the EVF 217 or the display unit 108.

In step S909, the system control unit 50 (the display control unit 606) displays the captured image acquired by the image acquisition unit 600, and ends this operation.

According to the processing of steps S903 to S908, the display control unit 606 performs control as follows. In the case where the focus adjustment is performed in the AF, the display control unit 606 performs control such that switching of an image to be displayed is performed from the captured image (the captured image having the plurality of image areas) to an enlarged image (a first enlarged image) obtained by enlarging an AF distance measurable area in any one of the plurality of image areas. In the case where the focus adjustment is performed in the MF, the display control unit 606 performs control such that switching of an image to be displayed is performed from the captured image to an enlarged image (a second enlarged image) obtained by enlarging any one of the plurality of image areas. In the case where the focus adjustment is performed in the AF, the display control unit 606 performs control such that switching of an image to be displayed is performed from the captured image to the first enlarged image when the lens capable of performing the AF is mounted, and to the second enlarged image when the lens capable of performing the AF is not mounted.

The processing in FIG. 9 assumes a case where the focus adjustment is performed in the MF on both the left-eye optical system 301L and the right-eye optical system 301R, and the second enlarged image is, for example, an image obtained by enlarging the left image area captured through the left-eye optical system 301L. In a case where the focus adjustment is performed in the MF only on one of the left-eye optical system 301L and the right-eye optical system 301R, the second enlarged image may be an enlarged image obtained by enlarging an image area captured through an optical system on which the focus adjustment is performed. For example, the second enlarged image may be an image obtained by enlarging the left image area in a case where the focus adjustment is performed only on the left-eye optical system 301L, and may be an image obtained by enlarging the right image area in a case where the focus adjustment is performed only on the right-eye optical system 301R.

The processing in steps S906 and S907 is basic processing in a case where the user does not designate the display area. The user can perform various types of customization such as switching of the display area and designation of the display area even in the case where the focus adjustment of either the AF or the MF is performed. For example, the display control unit 606 may perform control as follows.

The display control unit 606 may perform control such that switching of an image to be displayed is performed between a plurality of enlarged images corresponding to the plurality of image areas, respectively, in response to a user operation. For example, in a case where the left image area 501L is enlarged and displayed, the display control unit 606 may perform control to enlarge and display the right image area 501R when a predetermined button pressing operation or a touch operation on an area other than the enlarged image is performed. The area other than the enlarged image is, for example, the area 802 in FIG. 8A or an area 803 in FIG. 8B. Consequently, the user can easily check the focus adjustment results of both the left image area and the right image area.

When an area to be displayed is designated by a user, and in a case where the focus adjustment is performed, the display control unit 606 may perform control such that switching of an image to be displayed is performed from the captured image to a third enlarged image obtained by enlarging the area designated by the user. The display control unit 606 may perform control to display the third enlarged image instead of the first enlarged image or the second enlarged image. For example, in the case where the AF processing is performed, the display control unit 606 may perform control to enlarge and display an area wider (narrower) than the AF distance measurable area. In the case where the MF processing is performed, the display control unit 606 may perform control to enlarge and display a partial area designated by the user, instead of the entire area of the left image area or the right image area. In addition, the display control unit 606 may perform control to display the third enlarged image after the first enlarged image or the second enlarged image. For example, when an operation (for example, a touch operation) of designating the partial area is performed in a state where the left image area is enlarged and displayed, the display control unit 606 may perform control to further enlarge and display the designated area. Consequently, the user can easily check a focus adjustment result of a desired area.

The display control unit 606 may perform control to display the enlarged image at a magnification designated by the user. Consequently, the user can display the image with a desired size and check the focus adjustment result.

According to the embodiment, the focus adjustment result can be easily checked in the focus adjustment performed in both the AF and the MF. Note that, in the embodiment, the image displayed during the focus adjustment is changed from the captured image to the enlarged image in the focus adjustment performed in both the AF and the MF. However, the captured image may be changed to the enlarged image in at least one type of focus adjustment.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

For example, it is described that one image in which two image areas having a parallax are arranged side by side is acquired, but the number of image areas, that is, the number of optical systems, may be larger than two, and the arrangement of the plurality of image areas is not particularly limited.

In addition, the present disclosure is not limited to a camera and a PC and is applicable to any electronic device that can handle an image having a plurality of image areas corresponding to a plurality of optical systems. For example, the present disclosure is applicable to a PDA, a mobile phone terminal, or a portable image viewer, a printer device, a digital photo frame, a music player, a video game machine, an electronic book reader, a cloud server, and the like. Also, the present disclosure is further applicable to, for example, a video player, a display device (including a projector), a tablet terminal, a smartphone, an AI speaker, a home electrical appliance device, and an on-vehicle device. The disclosure is also applicable to a multi-view smartphone or the like with a plurality of optical systems of different types, such as a standard lens, a wide-angle lens, and a zoom lens.

According to the present disclosure, a focus adjustment result can be easily checked in specific focus adjustment (at least one of the autofocus and the manual focus).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-215488, filed on Dec. 21, 2023, which is hereby incorporated by reference herein in its entirety.

What is claimed is:

1. An electronic device comprising:
a processor; and
a memory storing a program which, when executed by the processor, causes the electronic device to
execute acquisition processing of acquiring a captured image having a plurality of image areas captured through a plurality of optical systems, respectively, and
execute display control processing of performing control to display the captured image,
wherein, in a case where focus adjustment is performed in autofocus (AF), control is performed in the display control processing such that an image to be displayed is switched from the captured image to an enlarged image obtained by enlarging an area in which the AF is performable in any one of the plurality of image areas.

2. An electronic device comprising:
a processor; and
a memory storing a program which, when executed by the processor, causes the electronic device to
execute acquisition processing of acquiring a captured image having a plurality of image areas captured through a plurality of optical systems, respectively, and
execute display control processing of performing control to display the captured image,
wherein, in a case where focus adjustment is performed in manual focus (MF), control is performed in the display control processing such that an image to be displayed is switched from the captured image to an enlarged image obtained by enlarging any one of the plurality of image areas.

3. The electronic device according to claim 1, wherein
in a case where focus adjustment is performed in manual focus (MF), control is performed in the display control processing such that an image to be displayed is switched from the captured image to a second enlarged image obtained by enlarging any one of the plurality of image areas.

4. The electronic device according to claim 3, wherein
in a case where the focus adjustment is performed in the MF only on any one of the plurality of optical systems, the second enlarged image is an enlarged image obtained by enlarging an image area captured through the optical system on which the focus adjustment is performed.

5. The electronic device according to claim 1, wherein
control is performed in the display control processing such that an image to be displayed is switched between a plurality of enlarged images corresponding to the plurality of image areas, respectively, in response to a user operation.

6. The electronic device according to claim 1, wherein
if an area to be displayed during focus is designated by a user adjustment, in a case where the focus adjustment is performed, control is performed in the display control processing such that an image to be displayed is switched from the captured image to a third enlarged image obtained by enlarging the area designated by the user.

7. The electronic device according to claim 1, wherein
control is performed in the display control processing such that the enlarged image is displayed at a magnification designated by a user.

8. The electronic device according to claim 1, wherein
in a case where focus adjustment is performed in the AF, in the display control processing,
if a lens capable of the AF is mounted, control is performed such that an image to be displayed is switched from the captured image to the enlarged image obtained by enlarging an area in which the AF is performable, and
if the lens capable of the AF is not mounted, control is performed such that an image to be displayed is switched from the captured image to an enlarged image obtained by enlarging any one of the plurality of image areas.

9. The electronic device according to claim 1, wherein
each of the plurality of optical systems includes a fish-eye lens, and
each of the plurality of image areas is an area of a circular fish-eye image.

10. The electronic device according to claim 1, wherein
the enlarged image is an equirectangular image.

11. A control method of an electronic device, comprising:
acquiring a captured image having a plurality of image areas captured through a plurality of optical systems, respectively; and
performing control to display the captured image,
wherein, in a case where focus adjustment is performed in autofocus (AF), control is performed such that an image to be displayed is switched from the captured image to an enlarged image obtained by enlarging an area in which the AF is performable in any one of the plurality of image areas.

12. A non-transitory computer readable medium that stores a program, wherein the program causes a computer to execute the control method according to claim 11.
